(19) United States
(12) Patent Application Publication
(10) Pub. No.: US 2024/0215619 A1
(43) Pub. Date: Jul. 4, 2024

(54) METHODS AND APPARATUS FOR NEUTRALIZING IRRITANTS RELEASED FROM A VEGETABLE BEING CUT

(71) Applicant: Rory Flanagan, Philadelphia, PA (US)

(72) Inventor: Rory Flanagan, Philadelphia, PA (US)

(21) Appl. No.: 18/468,725

(22) Filed: Sep. 17, 2023

Related U.S. Application Data
(60) Provisional application No. 63/407,781, filed on Sep. 19, 2022.
(60) Provisional application No. 63/421,194, filed on Nov. 1, 2022.
(60) Provisional application No. 63/529,502, filed on Jul. 28, 2023.

(51) Int. Cl. A23L 5/20

(52) U.S. Cl. CPC A23L 5/276

(57) ABSTRACT

When an onion is cut it releases the acidic gas syn-propanethial-S-oxide. Upon contact with the eye this gas causes irritation, stinging, pain, tears, and discomfort. In some embodiments, an alkaline mist is sprayed over a cut onion. The alkaline mist interacts with the acidic gas and neutralizes it. This prevents eye irritation and discomfort. In some embodiments, the mist is sprayed by a battery-powered mister. The mister is activated via a power button. Once activated, it will continuously distribute mist until it is deactivated.

### PRIORITY NOTICE

The present application claims priority under 35 U.S.C. § 119(e) to U.S. Provisional Patent Applications 63/407,781, 63/421,194 and 63/529,502.

### TECHNICAL FIELD OF THE INVENTION

The present invention relates in general to food preparation, and, more specifically, to a kitchen accessory for neutralizing irritants that are released when cutting a vegetable.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. The use of these marks is by way of example and should not be construed as descriptive or to limit the scope of this invention to material associated only with such marks.

### BACKGROUND OF THE INVENTION

Food preparation often involves the cutting of vegetables. Onion is a popular vegetable that is widely used around the world. It is a versatile ingredient that can be added to salads, soups, sandwiches, pastas, pies, casseroles, and many more dishes. Onions will typically be chopped, sliced, diced, or otherwise cut during preparation and cooking. A common technique for cutting an onion is with a handheld knife and a chopping board. The user holds the onion with one hand while using the knife to cut it with the other hand.

The problem is that cut onions emit gases that cause irritation of the user. This irritation mostly occurs around the eyes, and can lead to redness, soreness, a stinging sensation, an inability to keep the eyes open, and tears. An overview of the process by which the irritant gases are created when an onion is cut is as follows. Cutting an onion damages the cells within, breaking the cell walls. These damaged cells release enzymes called alliinases. Alliinases break down amino acid sulfoxides, generating sulfenic acids. A specific sulfenic acid (1-propenesulfenic acid) is rapidly acted on by a second enzyme, the lacrimatory factor synthase. This produces syn-propanethial-S-oxide, an acidic gas, and an irritant. Syn-propanethial-S-oxide diffuses through the air. Upon contact with the eye, it causes irritation. One of the body's natural reactions is to produce tears to dilute and flush out the irritant. The stinging sensation can become intense, preventing the user from keeping their eyes open. It can be difficult to see clearly as uncontrollable blinking and tears occur. This is dangerous when handling a sharp knife. The sensations themselves are unpleasant to experience. There is a need on the market for a simple device that prevents eye irritation during the process of cutting an onion.

It is to these ends that the present invention has been developed.

### SUMMARY OF THE INVENTION

An alkaline mist is sprayed over a vegetable during food preparation. In some embodiments, the vegetable is an onion. The irritant released from a cut onion is syn-propanethial-S-oxide. Syn-propanethial-S-oxide is an acidic gas. When an alkaline interacts with an acid a neutralization reaction occurs. By spraying alkaline mist over a cut onion syn-propanethial-S-oxide is partially or completely neutralized, thereby preventing eye-irritation. In some embodiments, the mist is generated by a battery-powered mister. The mister is filled with alkaline solution. The mister generates mist from alkaline solution and sprays it over an onion. The alkaline mist interacts with syn-propanethial-S-oxide and partially or completely neutralizes it. In some embodiments, the mister is activated via a power button. Once activated, it will continuously generate mist until it is deactivated. In some embodiments, the mister battery is rechargeable via a recharging cable port on the mister enclosure.

In some embodiments, the alkaline solution is formed by mixing an alkaline solute with aqueous solvent. In the first embodiment, the solute is sodium bicarbonate. In the second embodiment, the solute is potassium bicarbonate. In alternative embodiments, the alkaline solute is magnesium bicarbonate, or any other variations known in the art. An embodiment such as sodium bicarbonate is advantageous, as sodium bicarbonate tablet or powder is small and lightweight. This allows alkaline solution refills for the mister to be provided to the user in a more practical manner. Sodium bicarbonate can be shipped to the user, and mixed with water as required. Water is readily available in most kitchens. Shipping refills to the user in alkaline liquid format is less practical. Liquids are heavier and occupy a larger volume of space. A small quantity of tablet or powder sodium bicarbonate added to water forms an effective alkaline solution for neutralizing irritants. In some embodiments, the solute is in tablet format. The user adds a tablet to water to form an alkaline solution for filling the mister.

A method for neutralizing irritants from an onion comprising spraying such irritants with sodium bicarbonate solution in an amount of at least 1 gram of baking soda mixed with solvent.

In some embodiments, the mister generates mist from solution with reduced residue buildup. This is advantageous, as solution including a solute such as sodium bicarbonate leaves a residue when converted to mist. When using existing misters found on the market, residue buildup can cause clogging, blockages, as well as increased spoilage of misting elements and atomization discs. In some embodiments, generating mist from solution with reduced residue buildup is as follows. The mister is formed of two main parts, an air pump and a refillable liquid container. A flexible plastic tube is submerged in solution within the refillable liquid container. The plastic tube connects to an outlet hole in the liquid container. The air pump drives air over the outlet hole. This creates a low air pressure zone around the outlet hole. The low air pressure zone draws solution through the plastic tube and through the outlet hole. As solution passes through the outlet hole it is acted upon by the pumped air. The force of the air flow acting on the solution generates mist. The force of the pumped air continuously cleans the outlet hole, reducing residue buildup. This is advantageous. It converts solution to mist with reduced residue buildup, in a manner that is practical for a kitchen accessory. Industrial misters for solutions can have reduced residue buildup but are less practical in a kitchen accessory due to increased size and cost. This method is size and cost viable for a kitchen accessory.

In some embodiments, the two main parts of the mister can be separated. The two main parts being the refillable liquid container and the air pump. The liquid container disassembles for more effective cleaning and maintenance. All parts of the liquid container, both inside and outside, are easily accessible. This is advantageous for reducing residue buildup.

These and other advantages and features of the present invention are described herein with specificity so as to make the present invention understandable to one of ordinary skill in the art, both with respect to how to practice the present invention and how to make the present invention.

### BRIEF DESCRIPTION OF THE SEVERAL VIEWS OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1 is an illustrative representation of methods and apparatus for neutralizing irritants released from a vegetable being cut, showing the mister in close-up view, in accordance with embodiments of the present invention; and

FIG. 2 is an illustrative representation of methods and apparatus for neutralizing irritants released from a vegetable being cut, showing the method in use as an onion is cut, in accordance with embodiments of the present invention; and

FIG. 3 is an illustrative representation of methods and apparatus for neutralizing irritants released from a vegetable being cut, showing the internal components of the air pump enclosure, in accordance with embodiments of the present invention; and

FIG. 4 is an illustrative representation of methods and apparatus for neutralizing irritants released from a vegetable being cut, showing how syn-propanethial-S-oxide is produced as an onion is cut, as a system diagram, in accordance with embodiments of the present invention; and

FIG. 5 is an illustrative representation of methods and apparatus for neutralizing irritants released from a vegetable being cut, showing the method by which the mister generates a fine mist from alkaline solution, as a system diagram, in accordance with embodiments of the present invention; and

FIG. 6 is an illustrative representation of methods and apparatus for neutralizing irritants released from a vegetable being cut, showing the method of neutralizing irritant onion gases, as a system diagram, in accordance with embodiments of the present invention; and

FIG. 7 is an illustrative representation of methods and apparatus for neutralizing irritants released from a vegetable being cut, showing the two main parts of the mister separated, the air pump enclosure and the refillable liquid container, in accordance with embodiments of the present invention; and

FIG. 8 is an illustrative representation of methods and apparatus for neutralizing irritants released from a vegetable being cut, showing a close-up view of the pumped air exit hole and the alkaline solution outlet hole, in accordance with embodiments of the present invention.

### DETAILED DESCRIPTION OF THE INVENTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. Furthermore, there is no intention to be bound by any expressed or implied theory presented in the preceding technical field, background, summary, or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

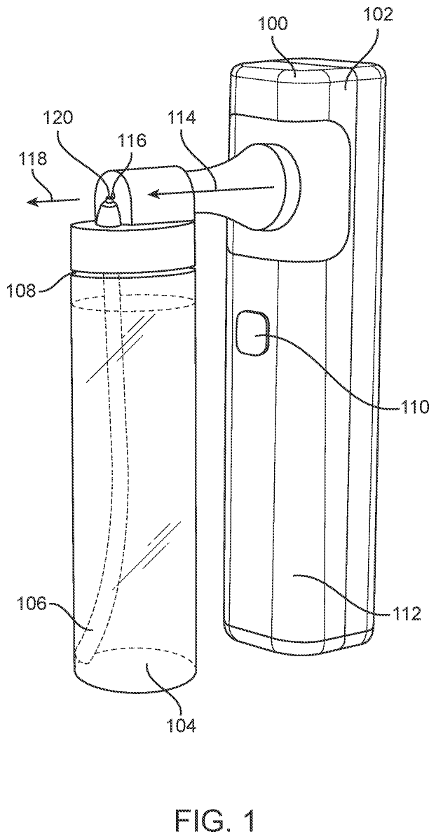

FIG. 1 is an illustrative representation of methods and apparatus for neutralizing irritants released from a vegetable being cut, showing the mister in close-up view, in accordance with embodiments of the present invention. The mister 100 is formed of two main parts, an air pump enclosure 102 and a refillable liquid container 104. The liquid container is filled with alkaline solution. In some embodiments the alkaline solution is sodium bicarbonate mixed with an aqueous solvent. A flexible plastic tube 106 is submerged in the alkaline solution. The refillable liquid container has a threaded top 108 that screws into the plastic enclosure. It can be unscrewed to refill the container with alkaline solution. The mister is turned on via a power button 110. Within the enclosure 112 is a battery-powered air pump. This pumps air in the direction indicated by the arrow 114. The pumped air leaves the enclosure via an exit hole 116. This pumped air passes over an outlet hole 120 in the refillable liquid container. The outlet hole in the refillable liquid container is connected to the flexible plastic tube 106. The air passing over the outlet hole in the refillable liquid container creates a low air pressure zone that draws alkaline solution through the flexible plastic tube and through the outlet hole. As the alkaline solution passes through the outlet hole in the refillable liquid container it interacts with the strong air flow created by the air pump. As the alkaline solution and pumped air interact, the force of the air generates mist from the alkaline solution. The mist is sprayed in a single direction indicated by the arrow 118.

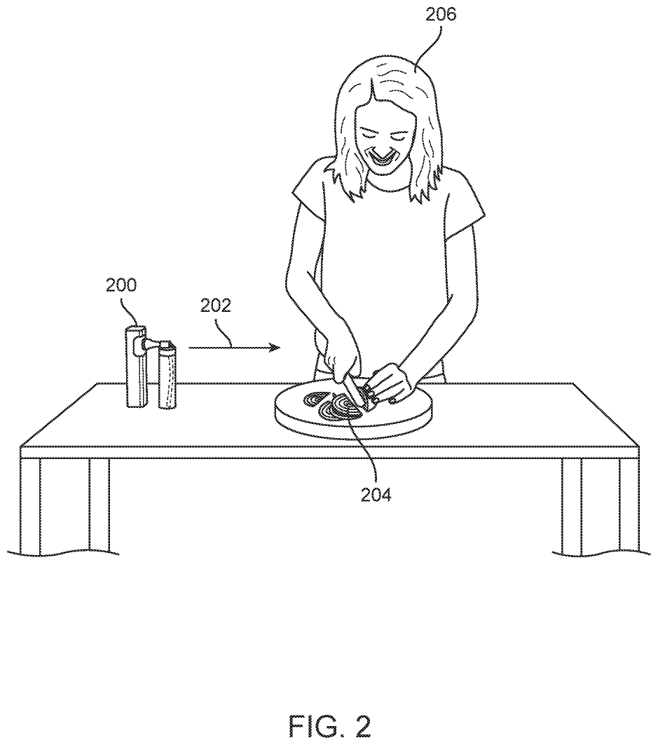

FIG. 2 is an illustrative representation of methods and apparatus for neutralizing irritants released from a vegetable being cut, showing the method in use as an onion is cut, in accordance with embodiments of the present invention. A mister 200 generates mist from alkaline solution and sprays it in the direction indicated by the arrow 202. An onion 204 is being cut which releases irritant acidic gases into the air. If these acidic gases come into contact with the eye of the user 206 it causes irritation, pain, and tears. The alkaline solution mist interacts with the acidic gas in the air and neutralizes it, thereby preventing irritation.

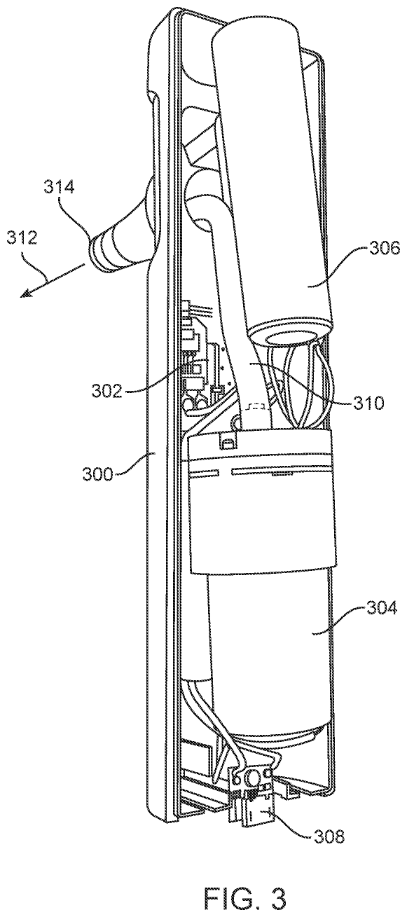

FIG. 3 is an illustrative representation of methods and apparatus for neutralizing irritants released from a vegetable being cut, showing the internal components of the air pump enclosure, in accordance with embodiments of the present invention. The enclosure 300 is open to show the internal components. These internal components include, but are not limited to, a PCB 302, an air pump 304, a rechargeable battery 306, a charging cable port 308, a flexible plastic tube 310 to carry air from the pump to the enclosure air exit hole 314. The arrow 312 indicates the direction of pumped air flow as it leaves the enclosure.

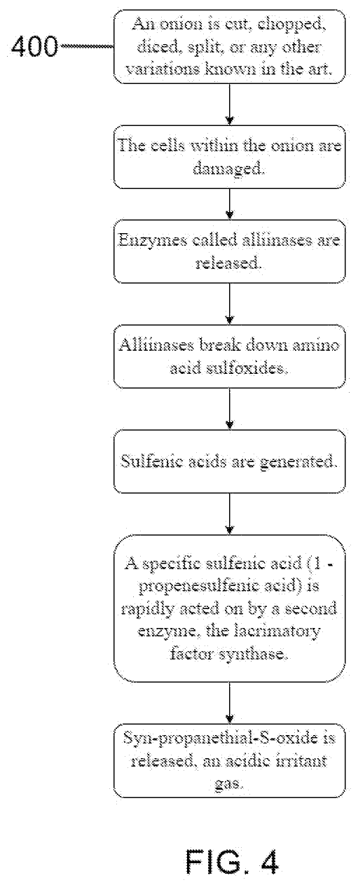

FIG. 4 is an illustrative representation of methods and apparatus for neutralizing irritants released from a vegetable being cut, showing how syn-propanethial-S-oxide is produced as an onion is cut, as a system diagram, in accordance with embodiments of the present invention. The process by which an onion produces syn-propanethial-S-oxide is shown as a system diagram 400. Syn-propanethial-S-oxide is an acidic gas that causes eye irritation.

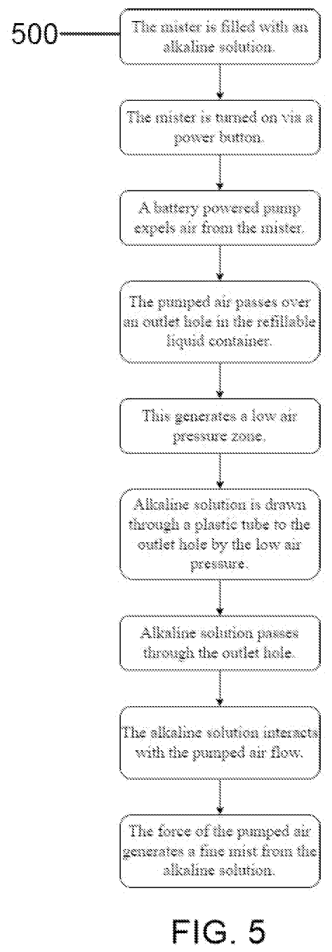

FIG. 5 is an illustrative representation of methods and apparatus for neutralizing irritants released from a vegetable being cut, showing the method by which the mister generates a fine mist from alkaline solution, as a system diagram, in accordance with embodiments of the present invention. The process by which the mister generates a fine mist from alkaline solution is shown as a system diagram 500. This process is advantageous as it reduces residue buildup. With traditional misters available on the market that do not benefit from this process, the sodium bicarbonate solute of the alkaline solution often remains as a residue after mist has been generated. This residue can accumulate and cause problems, including clogging and blockages. Misting elements and atomization discs spoil faster and need replacing more regularly when generating mist from alkaline solution.

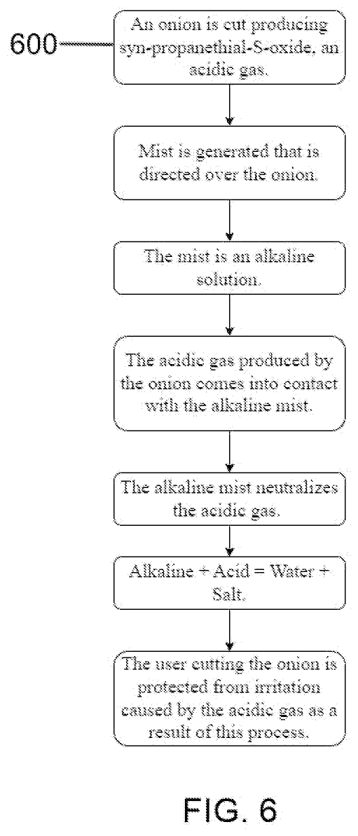

FIG. 6 is an illustrative representation of methods and apparatus for neutralizing irritants released from a vegetable being cut, showing the method of neutralizing irritant onion gases, as a system diagram, in accordance with embodiments of the present invention. The process of neutralizing irritant gases is shown as a system diagram 600.

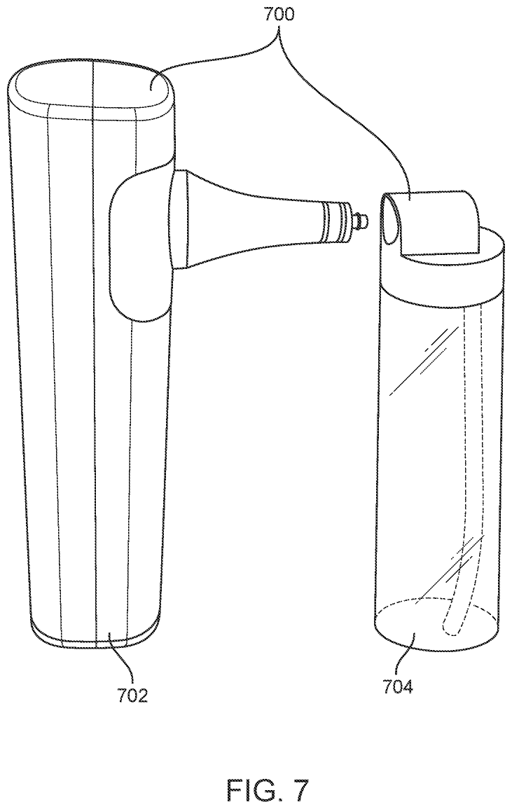

FIG. 7 is an illustrative representation of methods and apparatus for neutralizing irritants released from a vegetable being cut, showing the two main parts of the mister separated for clarity of features, in accordance with embodiments of the present invention. The mister 700 can be separated into two main parts. The air pump enclosure 702 and the refillable liquid container 704.

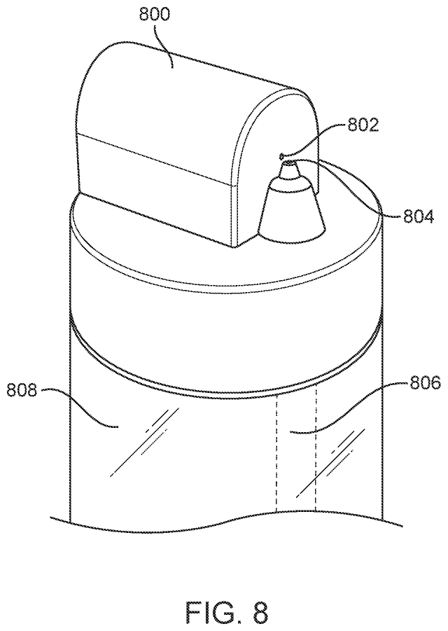

FIG. 8 is an illustrative representation of methods and apparatus for neutralizing irritants released from a vegetable being cut, showing a close-up view of the pumped air exit hole and the alkaline solution outlet hole, in accordance with embodiments of the present invention. The refillable liquid container 800 has an exit hole 802. Pumped air leaves the exit hole. There is an outlet hole 804 for the alkaline solution. The outlet hole connects to the flexible plastic tube 806. The flexible plastic tube is submerged in alkaline solution 808. As the pumped air leaving the exit hole 802 passes over the outlet hole 804 it creates a low air pressure zone. This air pressure draws alkaline solution through the plastic tube to the outlet hole. The alkaline solution is drawn through the outlet hole 804 and interacts with the pumped air flow. The force of the pumped air flow generates a fine mist from the alkaline solution. The alkaline solution mist is sprayed over an onion.

The mist targets syn-propanethial-S-oxide gas, or any other variations known in the art, and neutralizes it.

Alternative names for syn-propanethial-S-oxide gas include Thiopropanal S-oxide, and 1-Sulfinylpropane. The chemical formula is C₃H₆OS.

The mist intercepts and neutralizes syn-propanethial-S-oxide gas that is released as an onion is cut.

The mist may be used to neutralize any lachrymatory irritant such as those released by onions, honey garlic, or any other variations known in the art.

The alkaline solution is formed by mixing an alkaline solute with the solvent water. The solute may be an element, compound, mixture, or any other variations known in the art. The solute may contain sodium bicarbonate, potassium bicarbonate, cesium bicarbonate, magnesium bicarbonate, calcium bicarbonate, ammonium bicarbonate, sodium hydroxide, potassium hydroxide, a food-safe alkaline, a natural alkaline such as mint or peppermint, an alkaline binding agent such as agar-agar, or any other variations known in the art.

The solute that is added to water to form an alkaline solution may be in powder format, tablet format, liquid format, or any other variations known in the art.

The solute may be a proprietary mixture including, but not limited to, a food safe alkaline, a flavor neutralizer, a food safe fragrance, a food safe coloring, a binding agent such as agar-agar, or any other variations known in the art.

The solvent of the alkaline solution may be aqueous, non-aqueous, or any other variations known in the art.

The mist may be generated from water treated to have an oxygen molecule removed, an alkaline liquid, an alkaline solution, or any other variations known in the art.

Alkaline fruits, alkaline vegetables, alkaline teas, or any other variations known in the art, may be soaked in water to create an alkaline liquid for refilling the invention. Examples of common alkaline ingredients that may be used include spinach, quinoa, lentils, mint, peppermint, or any other variations known in the art.

The manufacturing method may make use of injection molding, rotational molding, compression molding, CNC milling, die casting, laser cutting, 3D printing, or any other variations known in the art.

The mister may be formed of HDPE plastic, PP plastic, recycled plastic, bamboo, glass, aluminum, stainless steel, or any other variations known in the art.

The mister may have one mist stream, two mist streams, three mist streams, or any other variations known in the art.

A mist stream may be directed above the onion, directed at the onion, directed around the user, or any other variations known in the art.

The mist may be generated via a misting element, an atomizer, a misting nozzle, a fogging nozzle, a liquid spray, a nano-mist spray, a brass misting nozzle, a ceramic misting nozzle, a stainless-steel misting nozzle, a flat fan nozzle, a full cone nozzle, a hollow cone nozzle, or any other variations known in the art.

The mister may be powered by a permanent battery, a removable battery, a replaceable battery, a primary battery, a secondary battery, a plug socket, mains electricity, utility power, domestic power, solar power, or any other variations known in the art.

The mister battery may be charged via a micro-USB cable, a USB-C cable, wireless charging, or any other variations known in the art.

The mister may be attached to a chopping board, attached to a kitchen knife, hung from a cupboard, hung from a wall, worn on the users body, attached to the users clothing, worn as a necklace, worn as glasses around the eyes, or any other variations known in the art.

The mist may be distributed via mist spray, air pump, vacuum pump, or any other variations known in the art.

The mister may be button activated, voice activated, infrared sensor activated, or any other variations known in the art.

The mister may be domestic size, commercial size, industrial size, covering a single onion, covering multiple onions, covering a single user, covering multiple users, covering a single chopping board, covering multiple chopping boards, or any other variations known in the art.

The mister may have a built-in mineralization filter that converts tap water to alkaline water after it has been poured into the liquid container. Mineralization filters alkalize the water with minerals like calcium, magnesium, and potassium. The mineralization filter may be replaceable. A reverse osmosis filter may be applied before the water passes through the mineralization filter.

While the invention has been described in connection with what is presently considered to be the most practical and preferred embodiments, it is to be understood that the invention is not to be limited to the disclosed embodiments, but, on the contrary, is intended to cover various modifications and equivalent arrangements included within the spirit and scope of the appended claims.

What is claimed is:

1. A method for neutralizing irritants from a vegetable, comprising:
an alkaline solution;
a mister; and
generating mist from said alkaline solution.

2. A method according to claim 1, wherein the vegetable is an onion.

3. A method according to claim 1, wherein the irritant is syn-propanethial-S-oxide.

4. A method according to claim 1, wherein the alkaline solution is sodium bicarbonate solute with aqueous solvent.

5. A method according to claim 1, wherein the alkaline solution is an alkaline tablet with aqueous solvent.

6. A method according to claim 1, wherein the alkaline solution is sprayed.

7. A method according to claim 1, wherein the mist is sprayed over a vegetable.

8. A method according to claim 1, wherein the alkaline solution solute is sodium bicarbonate, potassium bicarbonate, cesium bicarbonate, magnesium bicarbonate, calcium bicarbonate, ammonium bicarbonate, sodium hydroxide, potassium hydroxide, calcium hydroxide, or ammonium hydroxide.

9. An apparatus for neutralizing irritants from a vegetable, comprising:
a means for holding an alkaline solution; and
a mister connected to the alkaline solution, such that alkaline solution mist is generated.

10. An apparatus according to claim 9, wherein the vegetable is an onion.

11. An apparatus according to claim 9, wherein the irritant is syn-propanethial-S-oxide.

12. An apparatus according to claim 9, wherein the alkaline solution is sodium bicarbonate solute with aqueous solvent.

13. An apparatus according to claim 9, wherein the alkaline solution is an alkaline tablet with aqueous solvent.

14. A apparatus according to claim 9, wherein the alkaline solution is sprayed.

15. An apparatus according to claim 9, wherein the mist is sprayed over a vegetable.

16. An apparatus according to claim 9, wherein the alkaline solution solute is sodium bicarbonate, potassium bicarbonate, cesium bicarbonate, magnesium bicarbonate, calcium bicarbonate, ammonium bicarbonate, sodium hydroxide, potassium hydroxide, calcium hydroxide, or ammonium hydroxide.

17. A method for generating mist from solution with reduced residue buildup, comprising:
air being pumped over an outlet hole;
solution passing through the outlet hole; and
mist being generated as the solution interacts with the pumped air.

18. A method according to claim 17, wherein solution is powdered alkaline with aqueous solvent.

19. A method according to claim 17, wherein solution is alkaline tablet with aqueous solvent.

20. A method according to claim 17, wherein solution is sodium bicarbonate with aqueous solvent.
